(19) United States
(12) Patent Application Publication
(10) Pub. No.: US 2025/0268143 A1
(43) Pub. Date: Aug. 28, 2025

(54) SYSTEM AND METHOD FOR AN AGRICULTURAL HARVESTER

(71) Applicant: CNH Industrial Brasil Ltda., Nova Lima (BR)

(72) Inventors: Jean Carlos Pereira de Camargo, Piracicaba-SP (BR); Anderson Antonio Moreno, Piracicaba-SP (BR); Alessandro Roberto Pereira, Piracicaba-SP (BR); Daniel Rohrer Pereira, Piracicaba-SP (BR)

(21) Appl. No.: 19/062,766

(22) Filed: Feb. 25, 2025

(30) Foreign Application Priority Data
Feb. 26, 2024 (BR) 10 2024 003769 3

(51) Int. Cl. A01D 61/02; B65G 47/44

(52) U.S. Cl. CPC A01D 61/02; B65G 47/44

(57) ABSTRACT

An elevator assembly for a harvester may include an elevator housing and an elevator extending within the elevator housing between a proximal end portion and a distal end portion. The elevator may be configured to carry harvested crops between the proximal end portion and the distal end portion. A discharge assembly may be operably coupled with the elevator housing. The discharge assembly may include a discharge housing defining a discharge outlet, a deflector operably coupled with the discharge housing, and a discharge actuator operably coupled with the elevator housing and the discharge housing.

### FIELD OF THE INVENTION

The present disclosure relates generally to agricultural harvesters, such as sugarcane harvesters, and, more particularly, to systems and methods for an elevator assembly for an agricultural harvester.

### BACKGROUND OF THE INVENTION

Agricultural harvesters can include an assembly of processing components for processing harvested material. For instance, within a sugarcane harvester, severed sugarcane stalks are conveyed via a feed roller assembly to a chopper assembly that cuts or chops the sugarcane stalks into pieces or billets (e.g., six-inch cane sections). The processed harvested material discharged from the chopper assembly is then directed as a stream of billets and debris into a primary extractor, within which the airborne debris (e.g., dust, dirt, leaves, etc.) is separated from the sugarcane billets. The separated/cleaned billets then fall into an elevator assembly for delivery to an external storage device. However, in some instances, the billets may be directed to a common section of the storage device.

Additionally, when an external receiver is absent or is otherwise not properly positioned relative to the harvester, the elevator assembly may be stopped to prevent the conveyed billets from being discharged onto the ground. This situation can arise under a variety of conditions, such as if the accompanying receiver is full. As another example, the receiver may often be a towed wagon that (along with its towing vehicle) defines a larger turning radius than the harvester itself. In such instances, when a turn is being executed at the end of the field, the receiver may not be immediately present to receive the harvested crops. As a result, the harvester may have to pause operation until the receiver can be properly positioned relative to the harvester. In either situation, there is a loss in the productivity of the harvester.

Accordingly, an improved elevator assembly for an agricultural harvester would be welcomed in the technology.

### BRIEF DESCRIPTION OF THE INVENTION

Aspects and advantages of the invention will be set forth in part in the following description, or may be obvious from the description, or may be learned through practice of the invention.

In some aspects, the present subject matter is directed to an elevator assembly for a harvester that includes an elevator housing and an elevator extending within the elevator housing between a proximal end portion and a distal end portion. The elevator is configured to carry harvested crops between the proximal end portion and the distal end portion. A discharge assembly is operably coupled with the elevator housing. The discharge assembly includes a discharge housing defining a discharge outlet. The discharge housing is movable relative to the elevator housing. A deflector is operably coupled with the discharge housing.

In some aspects, the present subject matter is directed to a method for operating a harvester. The harvester can include an elevator assembly including an elevator extending between a proximal end portion and a distal end portion and a discharge assembly. The method includes conveying a material along the elevator in a direction from the proximate end portion to the distal end portion. The method also includes altering, with a discharge actuator, a position of a discharge housing of the discharge assembly relative to an elevator housing, the discharge assembly downstream of the elevator. Lastly, the method includes rotating a deflector operably coupled with the discharge housing.

In some aspects, the present subject matter is directed to an elevator assembly for a harvester that includes an elevator housing and an elevator configured to carry material there along. A discharge assembly is operably coupled with the elevator housing. The discharge assembly includes a discharge housing defining a discharge outlet. The discharge housing is movable relative to the elevator housing. A discharge actuator is operably coupled with the elevator housing and the discharge housing. The discharge actuator is configured to alter a position of the discharge housing relative to the elevator housing.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1A illustrates a simplified, side view of an agricultural harvester in accordance with aspects of the present subject matter;

FIG. 1B illustrates a simplified, side view of an agricultural harvester in accordance with aspects of the present subject matter;

FIG. 2 is a rear perspective view of an elevator assembly of the agricultural harvester in accordance with aspects of the present subject matter;

FIG. 3 is a cross-sectional view of the elevator assembly of FIG. 2 taken along the line III-III;

FIG. 4. is a side plan view of the elevator assembly with an ejection assembly housing and flap in a first position in accordance with aspects of the present subject matter;

FIG. 5 is a side plan view of the elevator assembly with an ejection assembly housing and flap in a second position in accordance with aspects of the present subject matter;

FIG. 6 is a side plan view of the elevator assembly with an ejection assembly housing and flap in a third position in accordance with aspects of the present subject matter; and

FIG. 7 illustrates a flow diagram of a method for agricultural harvesting in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part can be used with another embodiment to yield a still further embodiment. Thus, it is intended that the present invention covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to a harvested material along a path. For example, “upstream” refers to the direction from which a harvested material flows, and “downstream” refers to the direction to which the harvested material moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein will be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

As used herein, “harvested material” can include crop product, which may be in the form of stalks (or to be collected crop or after collected crop), billets (modified stalks or modified collected crop), and/or debris, which may be any object other than the stalks or the billets (or the collected crop) (e.g., dust, dirt, leaves, etc.).

In general, the present subject matter is directed to a system for an agricultural harvester. The system can include an elevator assembly for a harvester that may include an elevator housing and an elevator extending within the elevator housing between a proximal end portion and a distal end portion. The elevator may be configured to carry harvested crops between the proximal end portion and the distal end portion.

The elevator assembly may include and/or be operably coupled with a discharge assembly that is operably coupled with the elevator housing. The discharge assembly may include a discharge housing defining a discharge outlet. In some cases, the discharge housing may be movable relative to the elevator housing. A deflector may be operably coupled with the discharge housing. A discharge actuator may be operably coupled with the elevator housing and the discharge housing. The discharge actuator may be configured to alter a position of the discharge housing relative to the elevator housing. In some instances, the discharge assembly may be configured to receive inputs associated with a desired operating mode for the harvester 10 and/or a discharge location and, in turn, adjust a position of the discharge housing relative to the elevator housing.

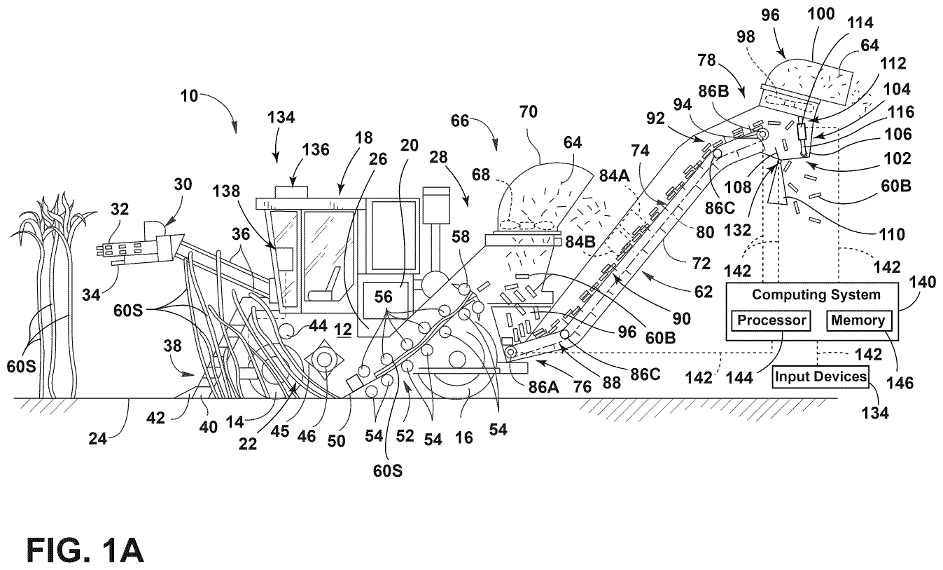

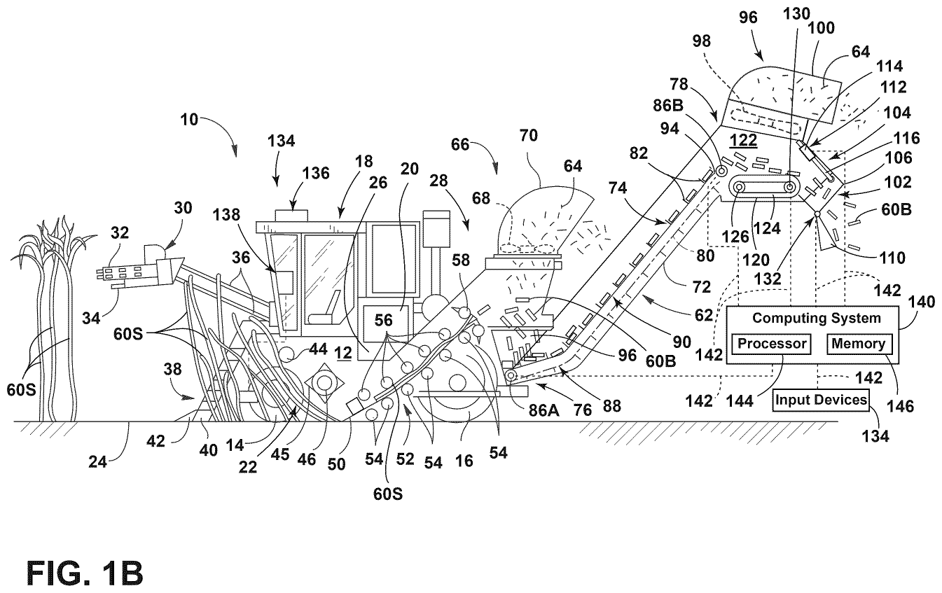

Referring now to the drawings, FIGS. 1A and 1B illustrate a harvester 10 configured as a sugarcane harvester. However, in other examples, the harvester 10 may correspond to any other suitable agricultural harvester. As shown in FIGS. 1A and 1B, the harvester 10 can include a frame 12, a pair of front wheels 14, a pair of rear wheels 16, and an operator's cab 18. The harvester 10 may also include a power source 20 (e.g., an engine mounted on the frame 12) that powers one or both pairs of the wheels 14, 16 via a driveline assembly 22 (e.g., a transmission) to traverse a field 24. Alternatively, the harvester 10 may be a track-driven harvester and, thus, may include tracks driven by the power source 20 as opposed to the illustrated wheels 14, 16. The power source 20 may also drive a hydraulic fluid pump 26 configured to generate pressurized hydraulic fluid for a hydraulic circuit, which may be configured to power various components of the harvester 10, including the driveline assembly 22.

The harvester 10 may also include a material processing system 28 incorporating various components, assemblies, and/or sub-assemblies of the harvester 10 for cutting, processing, cleaning, and discharging sugarcane as the cane is harvested from an agricultural field 24. For instance, the material processing system 28 may include a topper assembly 30 positioned at the front end portion of the harvester 10 to intercept sugarcane as the harvester 10 is moved in a forward direction. As shown, the topper assembly 30 may include both a gathering disk 32 and a cutting disk 34. The gathering disk 32 may be configured to gather the sugarcane stalks 60S so that the cutting disk 34 may be used to cut off the top of each stalk 60S. As is generally understood, the height of the topper assembly 30 may be adjustable via a pair of arms 36, which may be hydraulically raised and lowered.

The material processing system 28 may further include a crop divider 38 that extends upwardly and rearwardly from the field 24. In general, the crop divider 38 may include two spiral feed rollers 40. Each feed roller 40 may include a ground shoe 42 at its lower end portion to assist the crop divider 38 in gathering the sugarcane stalks 60S for harvesting. Moreover, as shown in FIGS. 1A and 1B, the material processing system 28 may include a knock-down roller 44 positioned near the front wheels 14 and a fin roller 46 positioned behind the knock-down roller 44. As the knock-down roller 44 is rotated, the sugarcane stalks 60S being harvested are knocked down while the crop divider 38 gathers the stalks 60S from agricultural field 24. Further, as shown in FIGS. 1A and 1B, the fin roller 46 may include a plurality of intermittently mounted fins 48 that assist in forcing the sugarcane stalks 60S downward.

Referring still to FIGS. 1A and 1B, the material processing system 28 of the harvester 10 may also include a base cutter assembly 50 positioned behind the fin roller 46. The base cutter assembly 50 may include blades for severing the sugarcane stalks 60S as the cane is being harvested. The blades, which may be located on a periphery section of the base cutter assembly 50, can be rotated by the hydraulic circuit. Additionally, in several examples, the blades may be angled downward to sever the base of the sugarcane as the cane is knocked down by the fin roller 46.

Moreover, the material processing system 28 may include a feed roller assembly 52 located downstream of the base cutter assembly 50 for moving the severed stalks 60S of sugarcane from base cutter assembly 50 along the processing path of the material processing system 28. As shown in FIGS. 1A and 1B, the feed roller assembly 52 may include a plurality of bottom rollers 54 and a plurality of opposed, top rollers 56. The various bottom and top rollers 54, 56 may be used to pinch the harvested sugarcane during transport. As the sugarcane is transported through the feed roller assembly 52, debris 64 (e.g., rocks, dirt, and/or the like) may be allowed to fall through bottom rollers 54 onto the field 24.

In addition, the material processing system 28 may include a chopper assembly 58 located at the downstream end section of the feed roller assembly 52 (e.g., adjacent to the rearward-most bottom roller 54 and the rearward-most top roller 56). In general, the chopper assembly 58 may be used to cut or chop the severed sugarcane stalks 60S into pieces or “billets” 60B, which may be, for example, six (6) inches long. The billets 60B may then be propelled towards an elevator assembly 62 of the material processing system 28 for delivery to an external receiver or storage device.

The debris 64 (e.g., dust, dirt, leaves, etc.) separated from the sugarcane billets 60B may be expelled from the harvester 10 through a primary extractor 66 of the material processing system 28, which may be located downstream of the chopper assembly 58 and may be oriented to direct the debris 64 outwardly from the harvester 10. Additionally, an extractor fan 68 may be mounted within an extractor housing 70 of the primary extractor 66 for generating a suction force or vacuum sufficient to force the debris 64 through the primary extractor 66. The separated or cleaned billets 60B, which may be heavier than the debris 64 expelled through the extractor 66, may then fall downward to the elevator assembly 62.

As shown in FIGS. 1A and 1B, the elevator assembly 62 may include an elevator housing 72 and an elevator 74 extending within the elevator housing 72 between a lower, proximal end portion 76 and an upper, distal end portion 78. In some examples, the elevator 74 may include a looped chain 80 and a plurality of flights or paddles 82 attached to and spaced on the chain 80. The paddles 82 may be configured to hold the sugarcane billets 60B on the elevator 74 as the sugarcane billets 60B are elevated along a top surface of the elevator 74 defined between its proximal and distal end portions 76, 78. A region 84 for retaining the harvested material may be defined between the first and second paddles 82 operably coupled with the elevator 74. As such, a first region 84A may be defined between first and second paddles 82, a second region 84B may be defined between the second and a third paddle 82, and so on. Additionally, the elevator 74 may include lower and upper sprockets 86A, 86B positioned at its proximal and distal end portions 76, 78, respectively. In some instances, the elevator 74 may include a first span 88, a second span 90 downstream of the first span 88, and a third span 92 downstream of the first span 88 and the second span 90. In such examples, the second span 90 can be offset from the first span 88 and the third span 92 may be offset from the first span 88 and/or the second span 90. In some cases, an intermediate sprocket 86C can be positioned between the first span 88 and the second span 90 and between the second span 90 and the third span 92.

As shown in FIGS. 1A and 1B, an elevator motor 94 may be coupled to one of the sprockets (e.g., the upper sprocket 86B) for driving the chain 80, thereby allowing the chain 80 and the paddles 82 to travel in a loop between the proximal end portions 76 and the distal end portion 78 of the elevator 74.

Moreover, in some examples, debris 64 (e.g., dust, dirt, leaves, etc.) separated from the elevated sugarcane billets 60B may be expelled from the harvester 10 through a secondary extractor 96 of the material processing system 28 coupled to the rear end portion of the elevator housing 72. For example, the debris 64 expelled by the secondary extractor 96 may be debris 64 remaining after the billets 60B are cleaned and debris 64 expelled by the primary extractor 66. As shown in FIGS. 1A and 1B, the secondary extractor 96 may be located adjacent to the distal end portion 78 of the elevator 74 and may be oriented to direct the debris 64 outwardly from the harvester 10. Additionally, an extractor fan 98 may be mounted within an extractor housing 100 of the secondary extractor 96 to generate a suction force or vacuum sufficient to force the debris 64 through the secondary extractor 96. The separated, cleaned billets 60B, heavier than the debris 64 expelled through the primary extractor 66, may then fall from the distal end portion 78 of the elevator 74.

In some instances, the billets 60B may fall through a discharge outlet 102 defined by a discharge assembly 104 into an external storage device, such as a sugarcane billet cart. In some instances, the discharge assembly 104 can include a discharge housing 106 that may be movable, pivotable, and/or translatable relative to the elevator housing 72. In various instances, the elevator housing 72 may define an elevator opening 108 and the discharge housing 106 may be positioned at least partially within the elevator opening 108. In some cases, a deflector 110 may be operably coupled with the discharge housing 106 and configured to prevent the motion of the billets 60B beyond the deflector 110.

In some cases, the discharge assembly 104 can further include a discharge actuator 112 configured to move the discharge housing 106 between various positions. In general, the discharge actuator 112 may correspond to any suitable actuation device. For instance, the discharge actuator 112 may correspond to a linear actuator, such as a fluid-driven cylinder actuator or an electric actuator (e.g., a solenoid-activated actuator). In such instances, the discharge actuator 112 may include an actuator housing 114 and a drive rod 116. In operation, by linearly actuating the drive rod 116 in one direction or the other, the discharge housing 106 may be moved relative to the elevator housing 72. In various examples, the actuator housing 114 may be operably coupled to the elevator assembly 62 and/or any other component of the harvester 10, and the drive rod 116 may be operably coupled to a portion of the discharge housing 106. Alternatively, the actuator housing 114 may be operably coupled to a portion of the discharge housing 106 and the drive rod 116 may be operably coupled to the elevator assembly 62 and/or any other component of the harvester 10. Additionally or alternatively, the discharge actuator 112 may correspond to any other suitable actuation device, such as any other suitable linear actuator (e.g., a gear and rack assembly).

Referring further to FIG. 1B, in some examples, the elevator assembly 62 may also include a storage hopper 118 at a location adjacent to the distal end portion 78 of the elevator 74 (e.g., at a location below the distal end portion 78 of the elevator 74 and the secondary extractor 96). As shown in FIG. 1B, the storage hopper 118 may include a conveyor 120 configured to carry the billets 60B received from the elevator 74 toward the discharge outlet 102 for ejection from the harvester 10. In this regard, when the harvester 10 is operated in an unloading mode, the conveyor 120 may be driven in a manner that carries the billets 60B expelled from the distal end portion 78 of the elevator 74 toward the discharge outlet 102 for ejection from the harvester 10. The ejected billets 60B may fall into an associated external receiver or storage device. However, when the harvester 10 is being operated in a storage harvesting mode, the speed of the conveyor 120 may be reduced or the operation of the conveyor 120 may be halted. As such, the billets 60B expelled from the distal end portion 78 of the elevator 74 may accumulate within a storage volume 122 defined by the storage hopper 118 for temporary storage therein.

In several examples, the conveyor 120 may extend within the storage hopper 118 between a first, forward end portion and a second, rear end portion. For example, as shown, the first end portion of the conveyor 120 may be positioned adjacent to the distal end portion 78 of the elevator 74 and a forward wall of the storage hopper 118, while the second end portion of the conveyor 120 may be positioned adjacent to a rear side of the hopper 118. Moreover, as shown, the conveyor 120 may be positioned vertically below the distal end portion 78 of the elevator 74. Additionally, the conveyor 120 may include a conveyor belt 124 and forward and rear rollers 126, 128 positioned at its first and second end portions, respectively. In this regard, a conveyor motor 130 (e.g., a hydraulic motor, electric motor, and/or any other practicable device) may be coupled to one of the rollers (e.g., the rear roller 126) for driving the conveyor belt 124, thereby allowing the belt 124 to travel in an endless loop between the first and second end portions of the conveyor 120. In such instances, the billets 60B discharged from the elevator 74 may fall onto a top span of the conveyor belt 124. Such billets 60B may, in turn, be carried or otherwise transported from the first end portion of the conveyor 120 to the second end portion of the conveyor 120 as the conveyor belt 124 is moved relative to the rollers 126, 128.

During operation, the harvester 10 traverses the agricultural field 24 for harvesting sugarcane. After the height of the topper assembly 30 is adjusted via the arms 36, the gathering disk 32 on the topper assembly 30 may function to gather the sugarcane stalks 60S as the harvester 10 proceeds across the field 24, while the cutting disk 34 severs the leafy tops of the sugarcane stalks 60S for disposal along either side of harvester 10. As the stalks 60S enter the crop divider 38, the ground shoes 42 may set the operating width to determine the quantity of sugarcane entering the throat of the harvester 10. The spiral feed rollers 40 then gather the stalks 60S into the throat to allow the knock-down roller 44 to bend the stalks 60S downwardly in conjunction with the action of the fin roller 46. Once the stalks 60S are angled downward as shown in FIGS. 1A and 1B, the base cutter assembly 50 may then sever the base of the stalks 60S from field 24. The severed stalks 60S are then, by the movement of the harvester 10, directed to the feed roller assembly 52.

The severed sugarcane stalks 60S are conveyed rearwardly by the bottom and top rollers 54, 56, which compresses the stalks 60S, makes them more uniform, and shakes loose debris 64 to pass through the bottom rollers 54 to the field 24. At the downstream end portion of the feed roller assembly 52, the chopper assembly 58 cuts or chops the compressed sugarcane stalks 60S or harvested material into pieces or billets 60B (e.g., 6-inch cane sections). The processed harvested material discharged from the chopper assembly 58 is then directed as a stream of billets 60B and debris 64 into the primary extractor 66. The airborne debris 64 (e.g., dust, dirt, leaves, etc.) separated from the billets 60B is then extracted through the primary extractor 66 using suction created by the extractor fan 68. The separated/cleaned billets 60B then be directed to an elevator hopper 118 into the elevator assembly 62 and travel upwardly via the elevator 74 from its proximal end portion 76 to its distal end portion 78.

During an unloading mode, once the billets 60B reach the distal end portion 78 of the elevator 74, the billets 60B fall through the elevator opening 108 to an external storage device. If provided, the secondary extractor 96 (with the aid of the extractor fan 98) blows out trash/debris 64 from the harvester 10, similar to the primary extractor 66. As provided herein, the discharge assembly 104 may be placed in various positions to direct the billets 60B in a defined direction such that the ejected billets 60B may fall into an associated external receiver or storage device. Additionally or alternatively, the harvester 10 may be operated in a storage harvesting mode. In such instances, the speed of the conveyor 120 may be reduced or the operation of the conveyor 120 may be halted, if a conveyor 120 is installed within the elevator assembly 62. In addition, the discharge housing 106 and/or the deflector 110 may be rotated such that the billets 60B are retained within the hopper 118. In some cases, the deflector 110 may be rotated relative to the discharge housing 106 through a deflector actuator 132 (e.g., a hydraulic motor, electric motor, and/or any other practicable device) that may be coupled to the discharge housing 106 (and/or any other component of the harvester 10). In some instances, the deflector actuator 132 may be configured to alter a position of the deflector 110 relative to the discharge housing 106 between a first position in which at least a portion of the discharge outlet 102 is blocked by the deflector 110 to define a storage harvesting mode and a second position in which at least a portion of the deflector 110 is positioned vertically below the discharge housing 106.

Referring back to FIGS. 1A and 1B, in several examples, the operation of the discharge actuator 112, the deflector actuator 132, and/or the conveyor motor 130 may be controlled through one or more input devices 134. In various examples, the one or more input devices 134 may include a sensor system 136, which may include one or more sensors configured to monitor various conditions (e.g., a position of an external storage device, a fill level of the hopper 118, and/or any other condition), one or more user interfaces 138 for allowing operator inputs to be provided (e.g., buttons, knobs, dials, levers, joysticks, touch screens, and/or the like), one or more other internal data sources associated with the harvester 10 (e.g., other devices, databases, etc.), one or more external data sources (e.g., a remote computing device or server), and/or any other suitable input devices 134.

As shown in FIGS. 1A and 1B, a computing system 140 may be operably coupled with the one or more input devices 134, which may be positioned within the cab 18 and/or in any other practicable location, via one or more communicative links 142, such as a wired connection and/or a wireless connection. Additionally or alternatively, the computing system 140 may also be operably coupled with the discharge actuator 112, the deflector actuator 132, and/or the conveyor motor 130 via one or more communicative links 142, such as a wired connection and/or a wireless connection. In examples in which the discharge actuator 112, the deflector actuator 132, and/or the conveyor motor 130 corresponds to a fluid-driven component(s), the computing system 140 may, instead, be communicatively coupled to suitable electronically controlled valves and/or other suitable fluid-related components for controlling the operation of the discharge actuator 112, the deflector actuator 132, and/or the conveyor motor 130. Regardless, by providing the disclosed communicative links 142 between the computing system 140 and the discharge actuator 112, the deflector actuator 132, and/or the conveyor motor 130, the computing system 140 may be configured to control the operation of the discharge actuator 112, the deflector actuator 132, and/or the conveyor motor 130. For instance, the computing system 140 may be configured to receive inputs associated with the desired operating mode for the harvester 10 and/or a discharge location. In such instances, the computing system 140 may receive an input indicating the desire to switch the operation of the harvester 10 from the discharge harvesting mode to the storage harvesting mode. In turn, the computing system 140 may be configured to electronically control the operation of the conveyor motor 130 to reduce the speed of and/or halt the operation of the conveyor 120 and electronically control the discharge assembly 104 to move to its closed position (via rotation of the discharge housing 106 and/or the deflector 110). Similarly, if the computing system 140 receives an input indicating the desire to switch the operation of the harvester 10 from the storage harvesting mode back to the discharge harvesting mode, the computing system 140 may be configured to electronically control the operation of the conveyor motor 130 such that the conveyor belt 124 is driven at the desired or selected speed and electronically control the discharge assembly 104 to move to its opened position (via rotation of the discharge housing 106 and/or the deflector 110). Additionally or alternatively, if the computing system 140 receives an input indicating a change in discharge location (e.g., to fill a different section of a storage container, based on a change in position of the storage container, and/or for any other purpose), the computing system 140 may be configured to electronically control the operation of the discharge actuator 112 to change a position of the discharge housing 106 relative to the elevator housing 72 and/or rotate the deflector 110 relative to the discharge housing 106.

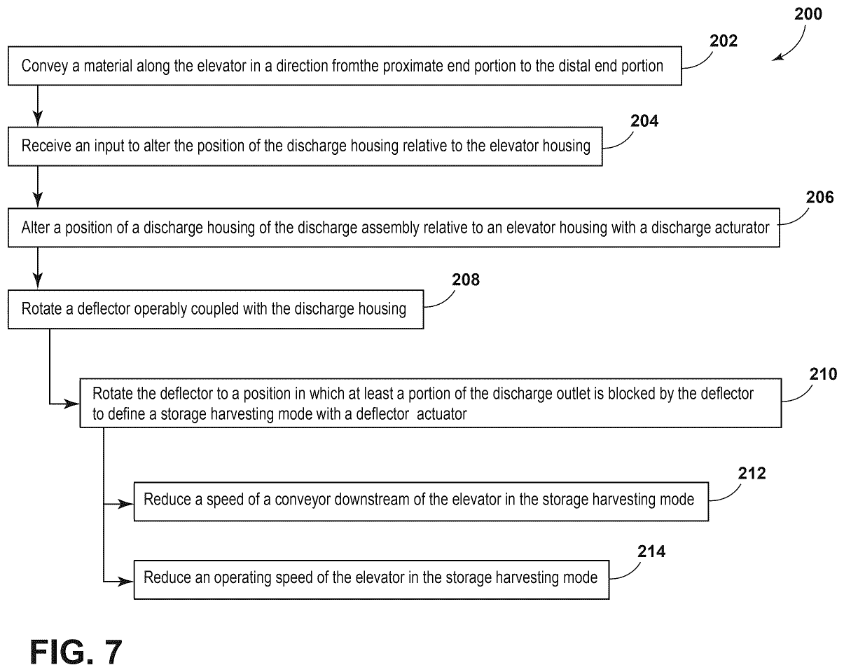

In general, the computing system 140 may correspond to any suitable processor-based device known in the art, such as a computing device or any suitable combination of computing devices. Thus, in several examples, the computing system 140 may include one or more processor(s) 144 and associated memory device(s) 146 configured to perform a variety of computer-implemented functions. As used herein, the term “processor” refers not only to integrated circuits referred to in the art as being included in a computer, but also refers to a computing system, a microcontroller, a microcomputer, a programmable logic controller (PLC), an application specific integrated circuit, and other programmable circuits. Additionally, the memory device(s) 146 of the computing system 140 may generally comprise memory element(s) including, but not limited to, computer readable medium (e.g., random access memory (RAM)), computer readable non-volatile medium (e.g., a flash memory), a compact disc-read only memory (CD-ROM), a magneto-optical disk (MOD), a digital versatile disc (DVD) and/or other suitable memory elements. Such memory device(s) 146 may generally be configured to store suitable computer-readable instructions that, when implemented by the processor(s) 144, configure the computing system 140 to perform various computer-implemented functions, such as one or more aspects of the method 200 described below with reference to FIG. 7. In addition, the computing system 140 may also include various other suitable components, such as a communications circuit or module, one or more input/output channels, a data/control bus and/or the like.

In various examples, the computing system 140 may correspond to an existing computing system of the harvester 10, or the computing system 140 may correspond to a separate processing device. For instance, in one example, the computing system 140 may form all or part of a separate plug-in module that may be installed within the harvester 10 to allow the present subject matter to be implemented without requiring additional software to be uploaded onto existing control devices of the harvester 10.

Additionally, the computing system 140 may be configured to electronically control any other suitable components of the harvester 10 in addition to the above-described components. For instance, as shown in FIGS. 1A and 1B, the computing system 140 may be communicatively coupled to the elevator motor 94 for controlling the operation of the elevator 74. For instance, the computing system 140 may electronically control the operation of the elevator motor 94 to automatically adjust the operational speed of the elevator 74 and/or the start/stop the elevator 74, as desired.

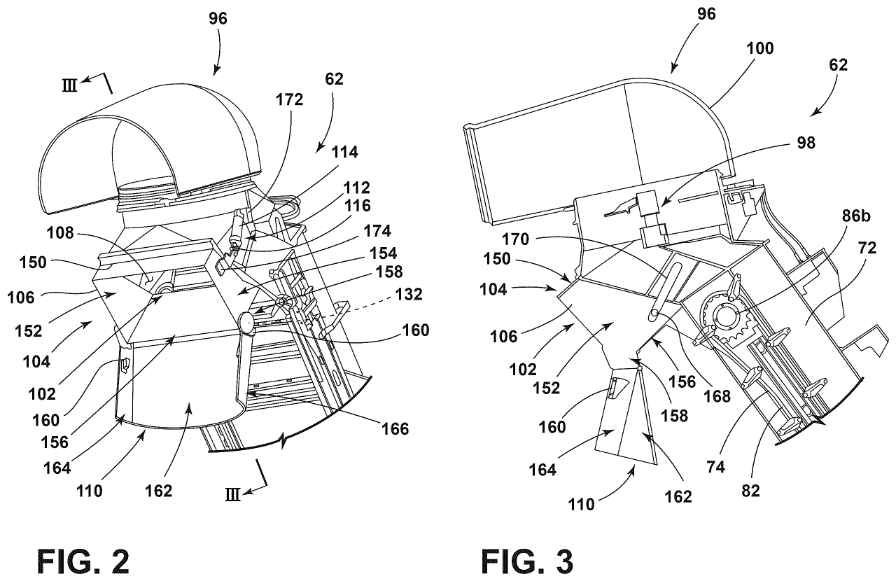

Referring now to FIGS. 2 and 3, the discharge housing 106 may include a top portion 150, a first side portion 152, a second side portion 154, and a bottom portion 156, which, in combination, define the discharge outlet 102. The housing may further define a bounded area, which may be the hopper 118 downstream of the elevator 74. The discharge housing 106 may further define a mounting portion 158. A deflector bracket 160 may be operably coupled with the mounting portion 158. The deflector bracket 160 may be operably coupled with the deflector 110 to allow the deflector 110 to rotate or otherwise move relative to the discharge housing 106.

As illustrated, the deflector 110 can include a central section 162, a first lateral end section 164, and a second lateral end section 166. In some cases, when the deflector 110 is rotated to a first portion relative to the discharge housing 106, the first lateral end section 164 may be positioned on an opposing side of the first side portion 152 of the discharge housing 106 from the bounded area and the second lateral end section 166 may be positioned on an opposing side of the second side portion 154 of the discharge housing 106 from the bounded area. Moreover, the central section 162 may cover at least a portion of the discharge outlet 102.

As provided herein, the discharge housing 106 may be movable relative to the elevator housing 72. In some cases, the discharge housing 106 may include a member 168 and the elevator housing 72 may include a guide 170 (or vice versa). In such instances, the guide 170 may direct the movement of the member 168 along the guide 170, which, in turn, can direct the movement of the discharge housing 106 relative to the elevator housing 72.

In some examples, movement of the discharge housing 106 relative to the elevator housing 72 may be accomplished with the assistance of the discharge actuator 112. As illustrated, the housing of the discharge actuator 112 may be operably coupled with a first link 172. The first link 172 may further be operably coupled with the elevator housing 72. Additionally or alternatively, the drive rod 116 of the discharge actuator 112 may be operably coupled with a second link 174. The second link 174 may further be operably coupled with the discharge housing 106. Any of the connections (e.g., the first link 172 to the elevator housing 72, the first link 172 to the discharge actuator 112, the second link 174 to the discharge actuator 112, and the second link 174 to the discharge housing 106) may be fixed or pivotable in various implementations. In various examples, the discharge actuator 112 may be directly coupled with the elevator housing 72 and/or the discharge housing 106 without the use of a link. In addition, as provided herein, the housing of the discharge actuator 112 may be operably coupled with the elevator housing 72 and the drive rod 116 may be operably coupled with the discharge housing 106, or vice versa.

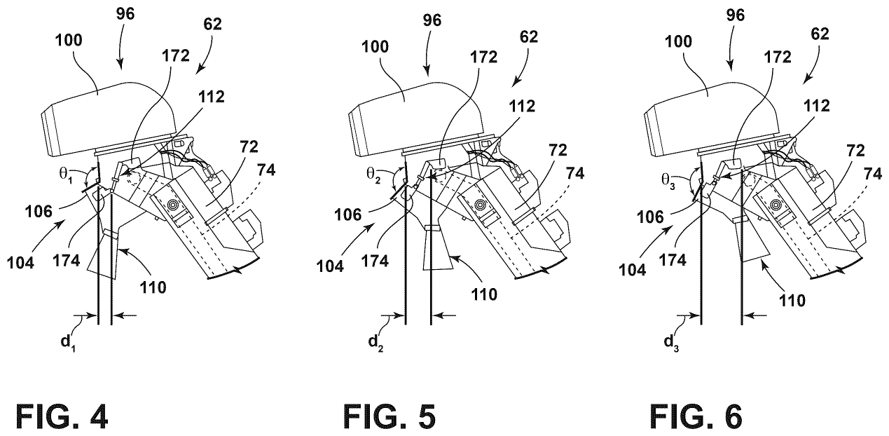

Referring now to FIGS. 4-6, in various examples, the elevator 74 within the harvester 10 may be of varied lengths. As such, a distance between the end portion of the elevator 74 and the elevator assembly 62 may also be varied. In various cases, the position of the discharge housing 106 relative to the elevator housing 72 may be at least partially based on the length of the elevator 74 within the elevator assembly 62. For instance, as shown in FIG. 4, a first elevator 74 may be positioned within the elevator assembly 62 and a first distance d₁ may be defined between the end portion of the elevator 74 and the rear wall of the elevator housing 72. Additionally or alternatively, as shown in FIG. 5, a second elevator 74 may be positioned within the elevator assembly 62 and a second distance de may be defined between the end portion of the elevator 74 and the rear wall of the elevator housing 72. Additionally or alternatively, as shown in FIG. 6, a third elevator 74 may be positioned within the elevator assembly 62 and a third distance d₃ may be defined between the end portion of the elevator 74 and the rear wall of the elevator housing 72. Based on the distance (e.g., the first distance d₁, the second distance d₂, and/or the third distance d₃), the discharge housing 106 may be positioned in a defined position relative to the elevator housing 72.

Additionally, as provided herein, to generally fill the storage container, and/or for any other reason, a discharge location may be varied. In such instances, the position of the discharge housing 106 relative to the elevator housing 72 may be altered. The discharge location may be based on data received from a sensor system 136 (onboard or remote from the harvester 10), received through a user input, and/or through any other manner. For instance, when the billets 60B are to be ejected in a first direction, a first offset angle θ₁ may be defined between the top portion 150 of the discharge housing 106 and a rearward portion of the elevator housing 72. When the billets 60B are to be ejected in a second direction, a second offset angle θ₂ may be defined between the top portion 150 of the discharge housing 106 and a rearward portion of the elevator housing 72. Likewise, when the billets 60B are to be ejected in a third direction, a third offset angle θ₃ may be defined between the top portion 150 of the discharge housing 106 and a rearward portion of the elevator housing 72. Each of the first angle θ₁, the second angle θ₂, and the third angle θ₃ may be varied from one another. Moreover, in some cases, the deflector 110 may be pivotably mounted to the discharge housing 106 and adjusted based on the position of the discharge housing 106. Additionally or alternatively, as provided herein, the position of the deflector 110 may be controlled independently of the discharge housing 106. In such instances, the deflector 110 may be positioned in any position as well based on the received inputs and/or for any other purpose.

Referring now to FIG. 7, a flow diagram of a method 200 for operating a harvester is illustrated in accordance with aspects of the present subject matter. In general, the method 200 will be described herein with reference to the agricultural harvester 10 and related components described with reference to FIGS. 1-6. However, it will be appreciated that the disclosed method 200 may be implemented with harvesters having any other suitable configurations and/or within systems having any other suitable system configuration. In addition, although FIG. 7 depicts steps performed in a particular order for purposes of illustration and discussion, the methods discussed herein are not limited to any particular order or arrangement. One skilled in the art, using the disclosures provided herein, will appreciate that various steps of the method disclosed herein can be omitted, rearranged, combined, and/or adapted in various ways without deviating from the scope of the present disclosure.

In various examples, the harvester can include an elevator assembly including an elevator extending between a proximal end portion and a distal end portion and a discharge assembly.

As shown in FIG. 7 at (202), the method 200 may include conveying a material along the elevator in a direction from the proximate end portion to the distal end portion. As provided herein, when the harvester is configured as a sugarcane harvester, severed sugarcane stalks are conveyed via a feed roller assembly to a chopper assembly that cuts or chops the sugarcane stalks into pieces or billets (e.g., six-inch cane sections). The processed harvested material discharged from the chopper assembly is then directed as a stream of billets and debris into a primary extractor, within which the airborne debris (e.g., dust, dirt, leaves, etc.) is separated from the sugarcane billets. The separated/cleaned billets then fall into the elevator assembly.

At (204), the method can include receiving an input to alter the position of the discharge housing relative to the elevator housing from an input device. In various examples, the input device includes at least one of an input device, an internal data source, an external data source, or a sensor system.

At (206), the method 200 can include altering a position of a discharge housing of the discharge assembly relative to an elevator housing with a discharge actuator. In some instances, a position of the deflector is based at least in part on a distance between the elevator and the elevator housing.

The discharge assembly downstream of the elevator nay may be configured to direct the harvested material in a defined direction and/or be used to assist in retaining the material within the elevator assembly for a defined time. In various examples, the discharge assembly can include a discharge housing that may be movable, pivotable, and/or translatable relative to the elevator housing. The discharge housing may define a discharge outlet. A deflector may be operably coupled with the discharge housing. A discharge actuator may be operably coupled with the elevator housing and the discharge housing.

At (208), the method 200 can include rotating a deflector operably coupled with the discharge housing. In some instances, the deflector may be rotated based on the position of the discharge housing. Additionally or alternatively, at (210), the method 200 can include rotating the deflector to a position in which at least a portion of the discharge outlet is blocked by the deflector to define a storage harvesting mode with a deflector actuator. Additionally, when in the storage harvesting mode, at (212), the method 200 can include reducing a speed of a conveyor downstream of the elevator in the storage harvesting mode and/or, at (212), the method 200 can include reducing an operating speed of the elevator in the storage harvesting mode. In an unloading mode, the deflector may be moved to a position in which at least a portion of the deflector is positioned vertically below the discharge housing.

In various examples, the method 200 may implement machine learning methods and algorithms that utilize one or several vehicle learning techniques including, for example, decision tree learning, including, for example, random forest or conditional inference trees methods, neural networks, support vector machines, clustering, and Bayesian networks. These algorithms can include computer-executable code that can be retrieved by the computing system and/or through a network/cloud and may be used to evaluate and update any performed processes. In some instances, the machine learning engine may allow for changes to be performed without human intervention.

It is to be understood that the steps of any method disclosed herein may be performed by a computing system upon loading and executing software code or instructions that are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions that are tangibly stored on a tangible computer-readable medium. The computing system loads the software code or instructions via a direct interface with the computer-readable medium or via a wired and/or wireless network. Upon loading and executing such software code or instructions by the controller, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as vehicle code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An elevator assembly for a harvester, comprising:
an elevator housing;
an elevator extending within the elevator housing between a proximal end portion and a distal end portion, the elevator configured to carry harvested crops between the proximal end portion and the distal end portion; and
a discharge assembly operably coupled with the elevator housing, the discharge assembly comprising:
a discharge housing defining a discharge outlet, the discharge housing movable relative to the elevator housing; and
a deflector operably coupled with the discharge housing.

2. The elevator assembly of claim 1, further comprising:
a discharge actuator operably coupled with the elevator housing and the discharge housing, the discharge actuator configured to alter a position of the discharge housing relative to the elevator housing.

3. The elevator assembly of claim 2, further comprising:
a first link operably coupled with the elevator housing and the discharge actuator.

4. The elevator assembly of claim 2, further comprising:
a second link operably coupled with the discharge housing and the discharge actuator.

5. The elevator assembly of claim 2, wherein the elevator housing defines an elevator opening, and wherein the discharge housing is positioned at least partially within the elevator opening.

6. The elevator assembly of claim 1, further comprising:
a member operably coupled with the discharge housing; and
a guide operably coupled with the elevator housing, wherein the guide is configured to direct a movement of the member along the guide.

7. The elevator assembly of claim 1, wherein the deflector may be positioned in a first position to direct harvested material in a defined direction downstream of the discharge housing and a second position to define a hopper.

8. The elevator assembly of claim 1, wherein the discharge housing is positioned at a first angle relative to the elevator housing in a first position and at a second angle relative to the elevator housing in a second position, the first angle varied from the second angle.

9. The elevator assembly of claim 2, further comprising:
a computing system operably coupled with the discharge actuator; and
an input device operably coupled with the computing system, wherein the computing system is configured to alter a position of the discharge housing relative to the elevator housing based on an input received through the input device.

10. A method for operating a harvester, the harvester comprising an elevator assembly including an elevator extending between a proximal end portion and a distal end portion and a discharge assembly, the method comprising:
conveying a material along the elevator in a direction from the proximate end portion to the distal end portion;
altering, with a discharge actuator, a position of a discharge housing of the discharge assembly relative to an elevator housing, the discharge assembly downstream of the elevator; and
rotating a deflector operably coupled with the discharge housing.

11. The method of claim 10, further comprising:
receiving, from an input device, an input to alter the position of the discharge housing relative to the elevator housing.

12. The method of claim 11, wherein the input device includes at least one of a user interface, an internal data source, an external data source, or a sensor system.

13. The method of claim 10, further comprising:
rotating, with a deflector actuator, the deflector to a position in which at least a portion of a discharge outlet defined by the discharge housing is blocked by the deflector to define a storage harvesting mode.

14. The method of claim 13, further comprising:
reducing a speed of a conveyor downstream of the elevator in the storage harvesting mode.

15. The method of claim 13, further comprising:
reducing an operating speed of the elevator in the storage harvesting mode.

16. The method of claim 10, wherein a position of the deflector is based at least in part on a distance between the elevator and the elevator housing.

17. An elevator assembly for a harvester, comprising:
an elevator housing;
an elevator configured to carry material there along; and
a discharge assembly operably coupled with the elevator housing, the discharge assembly comprising:
a discharge housing defining a discharge outlet, the discharge housing movable relative to the elevator housing; and
a discharge actuator operably coupled with the elevator housing and the discharge housing, the discharge actuator configured to alter a position of the discharge housing relative to the elevator housing.

18. The elevator assembly of claim 17, further comprising:
a deflector operably coupled with the discharge housing; and
a deflector actuator configured to alter a position of the deflector relative to the discharge housing between a first position in which at least a portion of the discharge outlet is blocked by the deflector to define a storage harvesting mode and a second position in which at least a portion of the deflector is positioned vertically below the discharge housing.

19. The elevator assembly of claim 17, further comprising:
a computing system operably coupled with the discharge actuator; and
an input device operably coupled with the computing system, wherein the computing system is configured to alter a position of the discharge housing relative to the elevator housing based on an input received through the input device.

20. The elevator assembly of claim 19, wherein the input device includes at least one of a user interface, an internal data source, an external data source, or a sensor system.
